(19) United States
(12) Patent Application Publication
(10) Pub. No.: US 2006/0004969 A1
(43) Pub. Date: Jan. 5, 2006

(54) High-speed accessible memory featuring reduced data movement

(76) Inventor: Takaya Suda, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/941,820

(22) Filed: Sep. 16, 2004

(30) Foreign Application Priority Data
Jun. 30, 2004 (JP) 2004-194328

(51) Int. Cl. G06F 12/00

(52) U.S. Cl. 711/154

(57) ABSTRACT

A control section includes an address information detection section detecting address information from a write command including address information, an address information storage section storing address information, and a first address determination section determining whether or not the address information detected by the address information detection section matches with the address information stored in the address information storage section. The control section stores directory entry information corresponding to the address information in the second storage section when receiving matching information from the first address determination section.

### CROSS-REFERENCE TO RELATED APPLICATIONS

This application is based upon and claims the benefit of priority from prior Japanese Patent Application No. 2004-194328, filed Jun. 30, 2004, the entire contents of which are incorporated herein by reference.

### BACKGROUND OF THE INVENTION

1. Field of the Invention

The present invention relates to a memory device such as memory card having a control section, and in particular, to its storage method.

2. Description of the Related Art

A file system is a system for managing data recorded in a memory device, and shows management areas of the storage medium and management information. The following methods exist as filing systems. One is a method of creating directory information such as file and folder in memory devices. Another is a method of moving and deleting these files and folders. Another is a method of using a data recording system and the location of management areas.

FIG. 7 shows a configuration of a FAT (File Allocation Table) file system having a 16 k-byte cluster size. The file system is composed of management area 701, several clusters A to D (702 to 705). The management area 701 of the file system has boot area 711, area 712, root directory entry area 713, FATA and FATB (714 and 715). The boot area 711 stores boot information, the area 712 stores partition information, and the root directory entry area 713 stores root directory entry information.

For example, in a state that the clusters A and C are used in the foregoing configuration, a file having a file name “AAA. txt” and a 32 k-byte file size is written to a memory device. In this case, the size of the file is larger than the cluster size. Due to this, the file is divided into a size based on the cluster unit, and thereafter, stored in an empty cluster of the memory device. More specifically, the file to be written has a 32 k-byte size; thus, the file is written using two clusters. In this case, these clusters do not need to be continuously arranged; for example, the file can be stored using clusters B and D.

In this case, management information is stored in FATA and FATB in order to manage to which cluster the file to be written is divided and it stored. These FATA and FATB store identical data, and if a defect occurs in one FAT, the data is repaired using the other FAT. The FATA and FATB store cluster information allocated to the file, and also, store a cluster link relation in the memory device. The information stored in FATA and FATB is traced, and thereby, the file is restored to the original file.

In this case, the first 16 k-bytes of the divided file is stored in the cluster B while the second 16 k-bytes thereof is stored in the cluster D. When the file divided into two clusters is read, the information stored in FATA and FATB is chain-connected, and thereby, the file is restored to the original state.

The root directory entry area 713 stores the following flag together with file name or folder name, file size, attribute and file updated date and time. The flag shows that which cluster shown in FATA and FATB is a leading cluster of the file. In this case, information stored in the root directory entry area 713 is as follows. The file name is “AAA. txt”, the file size is 32 k-byte, and the leading cluster is the cluster B.

The memory device using the file system described above is required to update root directory entry information and FAT management information in addition to write data when writing data.

On the other hand, a sub-directory having a sub-directory name “ABCDE” is created in a hierarchy lower than the root directory, and the file “AAA. txt” is written to the sub-directory.

As described above, the sub-directory is created in the hierarchy lower than the root directory; in this case, the sub-directory entry simply calls directory entry. In the sub-directory, “ABCDE” directory entry (32 bytes) is created in an empty cluster, like the file.

The content of the directory entry is information on a file existing in the sub-directory “ABCDE”, like the rot directory entry. In FIG. 7, for example, if clusters A and C are used while the cluster B is empty, “ABCDE” directory entry is written to the cluster B.

Information on the “ABCDE” directory entry is stored in the root directory entry area 713. More specifically, the root directory entry area 713 stores information indicative of which “ABCDE” directory entry is registered to which cluster.

When the file “AAA. txt” is written to the sub-directory “ABCDE”, the data of the cluster B stored with the “ABCDE” directory entry is updated. The cluster B has a 16 k-byte size; however, when the entry of directory entry is updated, write is frequently carried out at the minimum write size, that is, 512-byte size. The cluster B stores management information on a file or folder created in the hierarchy lower than the sub-directory “ABCDE”. In this case, the file name “AAA. txt”, file size and write start cluster address are registered in the cluster B.

In this case, the directory entry of the sub-directory “ABCDE” is written to cluster areas (data areas) other than the management area 701. Therefore, the address of a new directory entry of the sub-directory changes depending on cluster using conditions of the memory device. On the contrary, FAT and root directory entry are stored in a fixed address of the management area 701.

As described above, write is carried out with respect to the fixed address. In this case, there is provided a special storage area, which is capable of continuously storing write data corresponding to the address, and thereby, write efficiency is improved. However, the directory entry of the sub-directory positioned on the hierarchy lower than the root directory is stored in cluster areas other than the management area. The address stored with the directory entry of the sub-directory is specified by searching a directory entry positioned on the hierarchy lower than the root directory. However, if the sub-directory has several hierarchies, there is a problem that it is difficult to know the address of a desired directory entry positioned on the hierarchy lower than the directory entry in the memory device.

Therefore, the write operation to a memory card having a built-in NAND type flash memory was investigated using a personal computer and a card reader/writer connected via USB. Then, analysis was made with respect to directory entry, file write address and the frequency.

FIG. 8 shows the foregoing analysis result. As is evident from FIG. 8, write to FAT and directory entry is carried out several times before and after file data is written. In addition, the following can be seen from FIG. 8.

(1) The write size to FAT and directory entry is smaller than the file data.

(2) The write address to directory entry is always the same address.

(3) The write address to directory entry exists in cluster areas other than the management area.

(4) The address is non-continuous in the entire write flow.

When several files are written, many host devices repeat the foregoing flow.

In the NAND type flash memory, the minimum writable unit at one-time write request is called a page. For example, one page is composed of 512 or 2048 bytes. A data erase unit is called a block. For example, one block is composed of 32, 256 or 512 pages.

As described above, when the same file and folder is updated, write address to the corresponding directory entry has no change. For this reason, the same address data must be overwritten. However, the NAND type flash memory cannot make overwrite with respect to a page in which a write has already been made. If the memory makes the foregoing overwrite, erase is previously carried out. The erase of data is carried out per block; thus, if data is updated in page unit, the data update is carried out using erased block. In this case, data of a page to be overwritten and data of another page in the block to which the overwrite page belongs must be written to the erased block.

FIG. 9 shows the write operation when new write is performed with respect to a page C included in a block A.

When data is written to the page C of the block A, data of other pages A, B D, . . . N of the block A to which the page C belongs must be transferred to a block B. More specifically, data of pages A and B are transferred to the block B, and thereafter, data of new page C is written to the block B. Then, data of pages D . . . N must be transferred to the block B. For this reason, the amount of data movement increases even when small-capacity data of the page C is updated; as a result, write speed is reduced.

In order to solve the foregoing problem, the following method has been developed (see JPN. PAT. APPLN. KOKAI Publication No. 2003-280822, for example). According to the method, the amount of data movement is reduced as much as possible to improve the performance.

However, the technique disclosed in the foregoing Publication No. 2003-280822 relates to data other than that of a directory. In addition, as seen from the trace result of access to the NAND type flash memory shown in FIG. 8, the technique is not taken into consideration the write which is the few amount of data such as directory entry and many access frequency. Therefore, it is desired to provide a high-speed accessible memory device, which reduces data movement in the memory device when data is written into a directory entry having high access frequency.

### BRIEF SUMMARY OF THE INVENTION

According to a first aspect of the invention, there is provided a memory device comprising: a control section; and a storage section, the control section including: an address information detection section detecting address information from a write command including the address information; an address information storage section storing address information; and a first address determination section determining whether or not the address information detected by the address information detection section matches with the address information stored in the address information storage sections wherein the storage section includes first and second storage section, and the control section storing directory entry information corresponding to the address information in the second storage section when receiving matching information from the first address determination section.

According to a second aspect of the invention, there is provided a memory device comprising: a control section; a storage section; an address information detection section detecting address information from a write command including the address information; a cluster address information calculation section calculating cluster address information from address information detected by the address information detection section and cluster size information preset in the storage section; a cluster address information storage section storing the cluster address information supplied from the cluster address information calculation section; and a cluster address determination section determining whether or not the cluster address information calculated by the cluster address information calculation section matches with the cluster address information stored in the cluster address information storage section, wherein the storage section includes first and second storage section, and the control section storing directory entry information corresponding to the cluster address information in the second storage section when receiving matching information from the cluster address determination section.

According to a third aspect of the invention, there is provided a storage method of a memory device comprising: detecting an address information from a write command including the address information; determining whether or not the detected address information matches with an address information stored in an address information storage section, and storing write data in a first storage section of a storage section when the detected address information does not match with the address information stored in an address information storage section; storing the detected address information in the address information storage section when the data size of the write data is smaller than size information preset in the storage section; and storing directory entry information corresponding to the cluster address information in the second storage section when the detected address information matches with the address information stored in an address information storage section.

According to a fourth aspect of the invention, there is provided a storage method of a memory device comprising: detecting address information from a write command including the address information; calculating a cluster address information from address information detected by the address information detection section and cluster size information preset in the storage section; determining whether or not the calculated cluster address information matches with the cluster address information stored in the cluster address information storage section, and storing write data in a first storage section of a storage section when the calculated cluster address information does not match with the cluster address information stored in the cluster address information storage section; storing the calculated cluster address information in the address information storage section when the data size of the write data is smaller than size information preset in the storage section; and storing directory entry information corresponding to the cluster address information in the second storage section when the calculated cluster address information matches with the cluster address information stored in the cluster address information storage section.

### BRIEF DESCRIPTION OF THE SEVERAL VIEWS OF THE DRAWING

FIG. 1 is a view to explain the configuration of a memory device according to a first embodiment of the present invention;

FIG. 2 is a flowchart to explain the operation of FIG. 1;

FIG. 3 is a view to explain the operation of a storage section shown in FIG. 1;

FIG. 4 is a view to explain the configuration of a memory device according to a second embodiment of the present invention;

FIG. 5 is a flowchart to explain the operation of FIG. 4;

FIG. 6 is a flowchart to explain the startup operation of the memory device;

FIG. 7 is a view showing the configuration of a FAT file system;

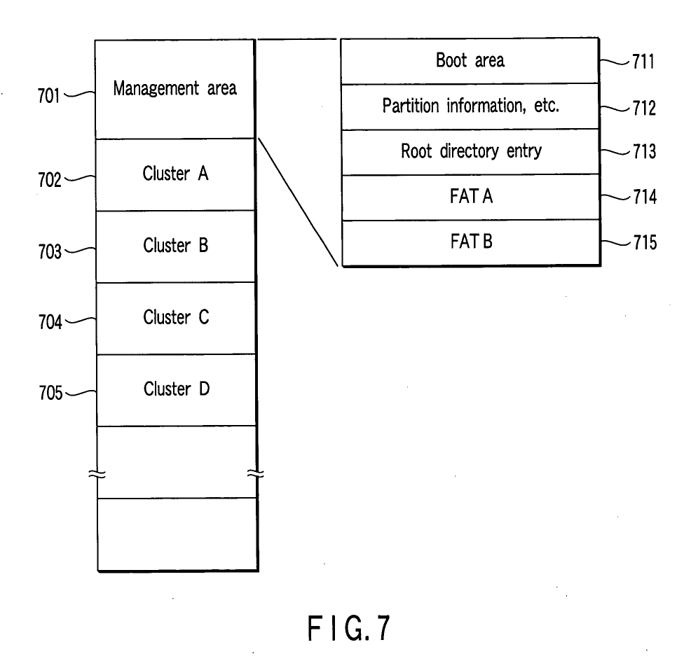

FIG. 8 is a view to explain the operation of the FAT file system; and

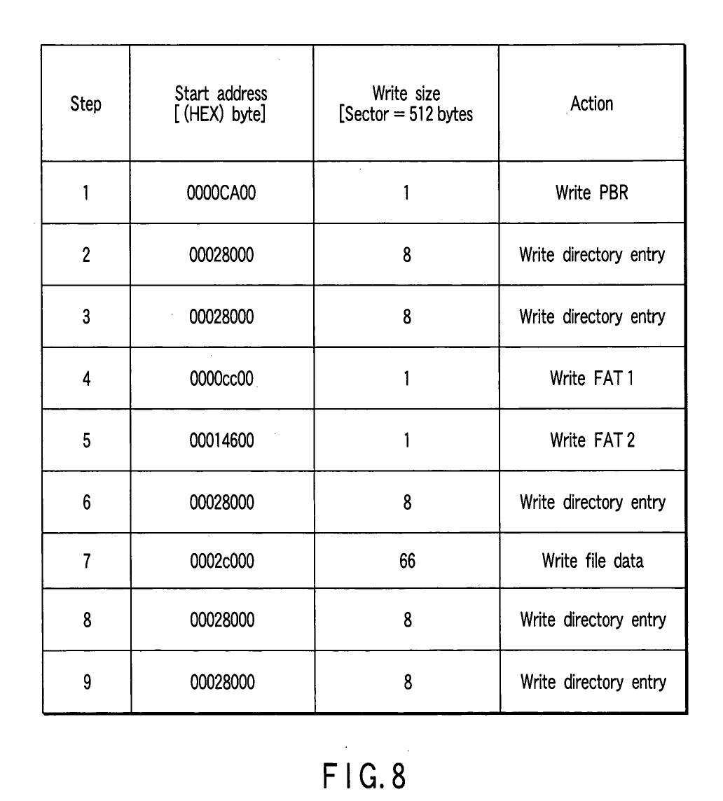

FIG. 9 is a view to explain the concept of data movement in a memory device using a NAND type flash memory.

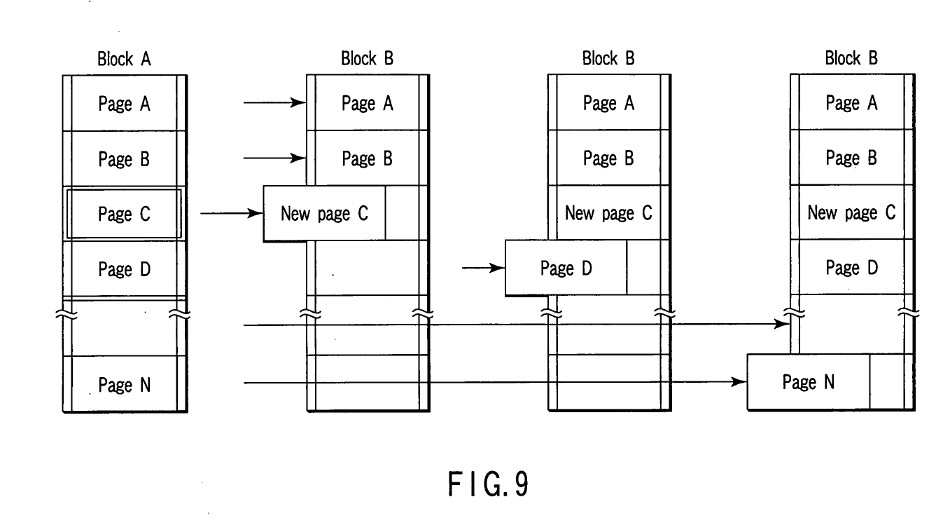

### DETAILED DESCRIPTION OF THE INVENTION

Embodiments of the present invention will be described below with reference to the accompanying drawings.

### First Embodiment

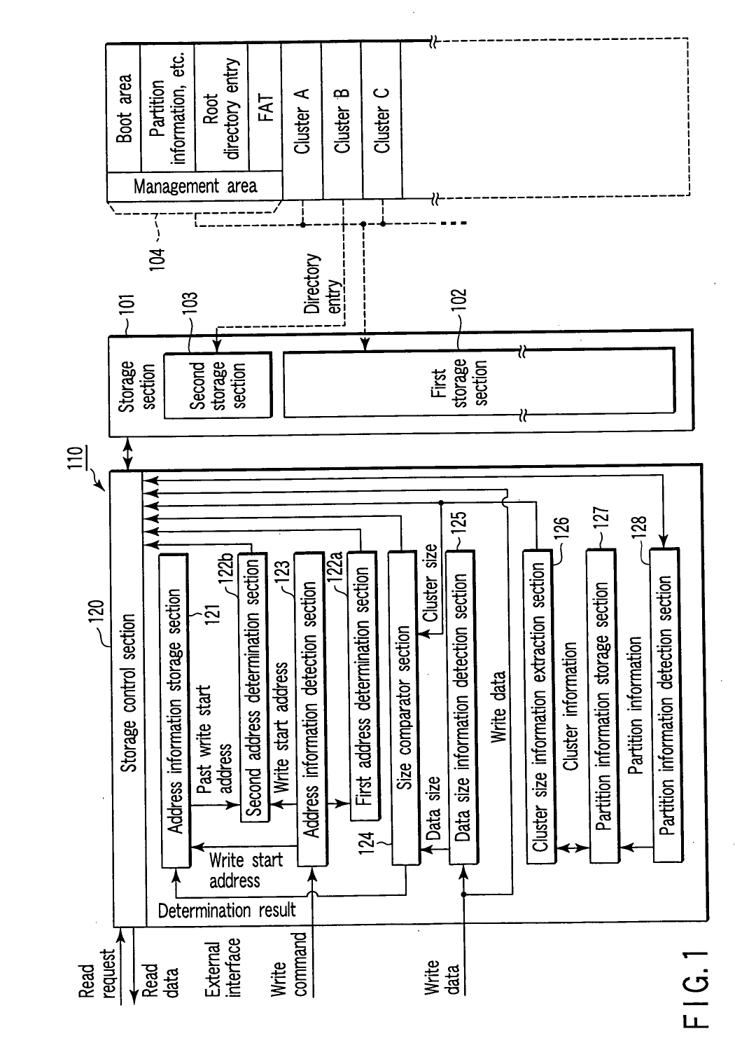

FIG. 1 shows a memory device used as a memory card having a control section and a NAND type flash memory.

In FIG. 1, a storage section 101 comprising a NAND flash memory has first and second storage sections 102 and 103. The first storage section 102 is stored with a management area and several clusters A, B, C . . . . The management area includes boot area, area storing partition information, root directory entry and FAT.

The second storage section 103 corresponds to one cluster of the first storage section 102. A directory entry (sub-directory information) diverging from the management area of the system is written in the second storage section 103. A new data is once written in the second storage section 103 if the data of the same directory entry is updated, as described later. For example, file name, file size and write start address are given as the directory entry.

A control section 110 includes storage control section 120, address information storage section 121, first and second address determination section 122a and 122b, address information detection section 123 and size comparator section 124. The control section 110 further includes data size information detection section 125, cluster size extraction section 126, partition information storage and detection section 127 and 128.

The control section 110 is not limited to the configuration described above. For example, the control section 110 comprises a microprocessor (not shown) and ROM or RAM storing programs necessary for the operation of the microprocessor, and may be controlled using software.

The storage control section 120 carries out write and read control for directory entry and file data with respect to first and second storage sections 102 and 103 in accordance with information from external interfaces and various sections.

The address information detection section 123 detects a write start address added to a write command supplied via the external interfaces.

The address information storage section 121 stores the write start address detected by the address information detection section 123 in accordance with the control of the size comparator section 124 described later.

The first address determination section 122a determines whether or not the write start address detected by the address information detection section 123 is an address in the management area of the file system. The determination result is supplied to the storage control section 120.

The second address determination section 122b compares the write start address detected by the address information detection section 123 with write start address information stored in the address information storage section 121. The comparative result is supplied to the storage control section 120.

The data size information detection section 125 detects a size of write data supplied via the external interfaces. The write data is written in the first or second storage section 102 or 103 via the storage control section 120.

The size comparator section 124 compares the data size detected by the data size information detection section 125 with a cluster size supplied from the cluster size extraction section 126. The comparative result is supplied to the address information storage section 121 and the storage control section 120. The address information storage section 121 stores the write start address detected by the address information detection section 123 in the case given below. That is, the section 121 stores the write start address if the size comparator section 124 determines that the size of the write data is less than the cluster size.

The partition information detection section 128 detects information including preset partition and cluster information from data read from the management area of the storage section 101 in accordance with a read request from the host device (not shown).

The partition information storage section 127 stores information including preset partition and cluster informations detected by the partition information detection section 128. The section 127 has the initial value preset in product delivery considering the case where the partition information is not detected.

The cluster size extraction section 126 extracts a cluster size stored in the partition information storage section 127.

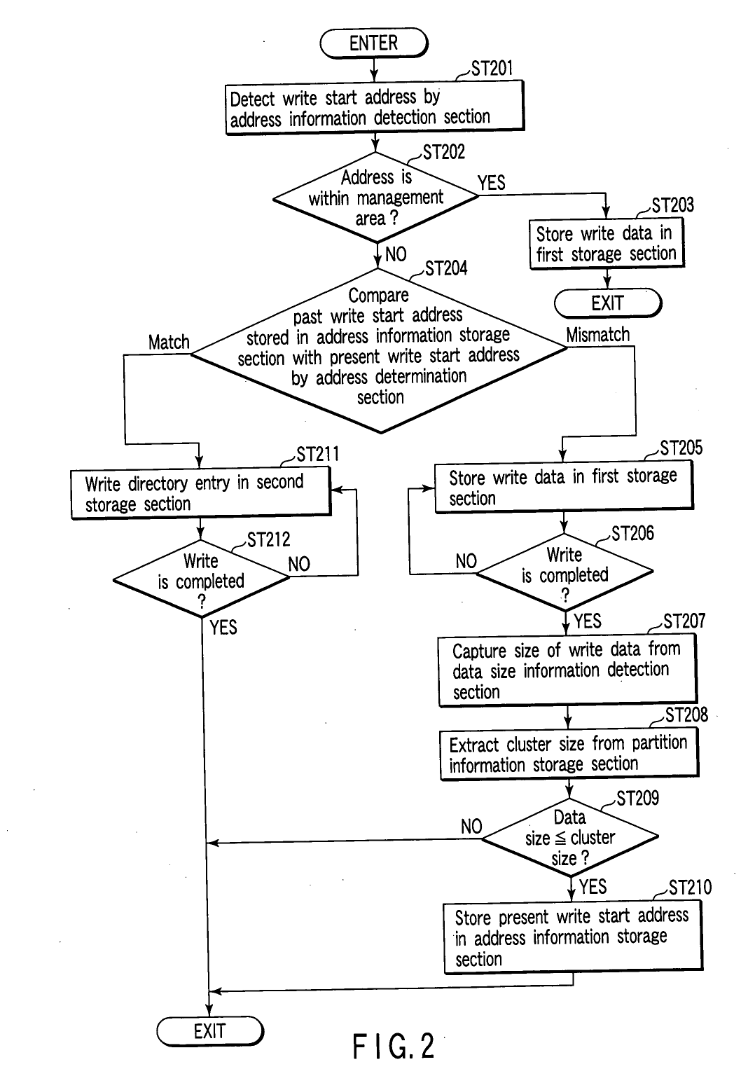

The write operation of the first embodiment will be described below with reference to FIG. 2.

The address information detection section 123 detects write start address information added to a write command supplied via the external interfaces (not shown)(ST 201). Thereafter, first address determination section 122a determines whether or not the write start address detected by the address information detection section 123 is an address in the management area (ST 202). As a result, if the write start address is within the management area, data is written in the first storage section 102 (ST 203). In other words, normal write is carried out with respect to data relevant to FAT and root directory.

On the other hand, if the write start address is outside of the management area, the second address determination section 122b perform makes the following determination. The section 122b determines whether or not the address information detected by the foregoing 123 is the same as the write start address information stored in the address information storage section 121. In other words, the section 122b determines whether or not write is made with respect to the address in the past (ST 204).

As a result, if the write start address is an address having no write in the past, data is written in an empty cluster of the first storage section 102 (ST 205, ST 206). In this case, the data size information detection section 125 detects a size of data written in the storage section 101 via the external interfaces.

When data storage to the first storage section 102 is completed, the size comparator section 124 captures a size of the data written in the first storage section 102 from the data size information detection section 125 (ST 207). Further, the section 124 captures a cluster size extracted by the partition information storage section 127 from the cluster size extraction section 126 (ST 208). Then, the size comparator section 124 compares the size of the written data with the cluster size (ST 209).

As a result, if the data size is less than the cluster size, the write data is determined as write to directory. The write start address information detected by the address information detection section 123 is stored in the address information storage section 121 (ST 210). On the other hand, if the data size is larger than the cluster size, the normal write operation is carried out.

In the comparison result in step ST 204, the write address matches with the address stored in the address information storage section 121. In other words, if slight data write is made with respect to the address in the past, the present write data is regarded as write to directory entry. For this reason, data is once written in the second storage section 103 provided for directory entry (ST 211, ST 212).

As described above, even if directory entry is written in the first storage section 102 used as data area of the file system, directory entry is written in the second storage section 103 after second-time write of directory entry.

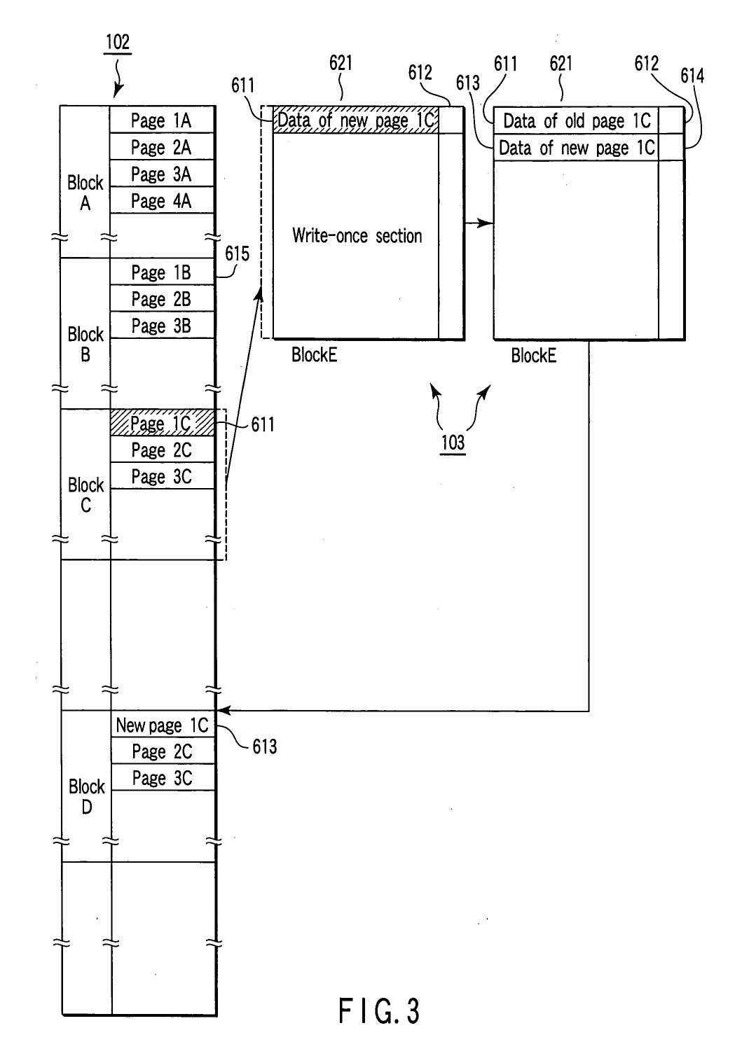

FIG. 3 is a view to explain the write operation to first and second storage sections 102 and 103.

In FIG. 3, blocks A to D correspond to the first storage section 102; on the other hand, a block E corresponds to the second storage section 103. The size of each area is determined as follows. One page is 512 bytes, one block is 16 k-bytes, one cluster is 16 k-bytes, and one directory entry is 32 bytes.

In the comparison result in step ST 204, if the write address matches with the address stored in the address information storage section 121, the write data is regarded as directory entry. In this case, data of a new page 1C is written as the directory entry in the page 1 of the erased block E shown in FIG. 3. If the directory entry corresponds to data write to a page 1C of the block C, data indicative of the page 1C of the block C is written in a redundancy area 612 provided in the page 1 of the block E.

In the next write, if the detected write address again matches with the address stored in the address information storage section 121, new directory entry is once written in a page 2 of the block E. Data indicative of the page 1C of the clock C is written in a redundancy area 614 of the page of the block E. In the manner described above, new directory entry is once written in the block E with respect to the write operation to the same write address as the address information storage section 121.

The NAND type flash memory writes data at the page unit; therefore, write-once is possible at the page unit. Thus, there is no need of moving data to a new erased block in a write-once enable range.

For example, if a change is made in the address determined as directory entry, directory entry stored in the block C is updated based on the directory entry written once in the block E according to predetermined timing. The update operation of the directory entry is carried out according to the following procedure. First, a page updated by the directory entry stored in the block E is detected referring to the redundancy area of the page of the block E. In this case, data indicative of the page 1C of the block C is written in the redundancy area of the page of the block E; therefore, the page 1C of the block C is detected as updated page. The latest directory entry (i.e., data of page 2 of block E) of the directory entry written once in the block E is transferred to a first page of the erased block D. Thereafter, the remaining data of the block C having no data update is transferred to pages after the second page of the block D. By doing so, the directory entry stored in the block C is updated.

Incidentally, the address information storage section 121 requires a capacity capable of holding at least two addresses. This is because the final cluster used in the file is not written at the cluster unit, and stored as data having a size smaller the cluster unit. In this case, the last write address of the file is erroneously determined as directory entry; as a result, the write address is stored in the address information storage section 121. Therefore, of addresses stored in the address information storage section 121, there exists an address, which is not regarded as a directory entry, in several-time writes. The address may be erased when it is stored in the address information storage section 121 the next time.

According to the first embodiment, when the data size is less than the cluster size and data is written in the same write address as the address information storage section 121, the following write operation is carried out. More specifically, directory entry is written in the second storage section 103 of the storage section 101 at the page unit. Thus, there is no need of data movement to a new erased block in a write-once enable range. Therefore, even if sub-directory is set in the hierarchy lower than the root directory, it is possible to prevent the reduction in write speed.

In addition, the redundancy area of the second storage section 103 is stored with data indicative of write-once page. Thus, when the memory device powers on, the host device can detect write-once page more readily than data stored in the redundancy area.

### Second Embodiment

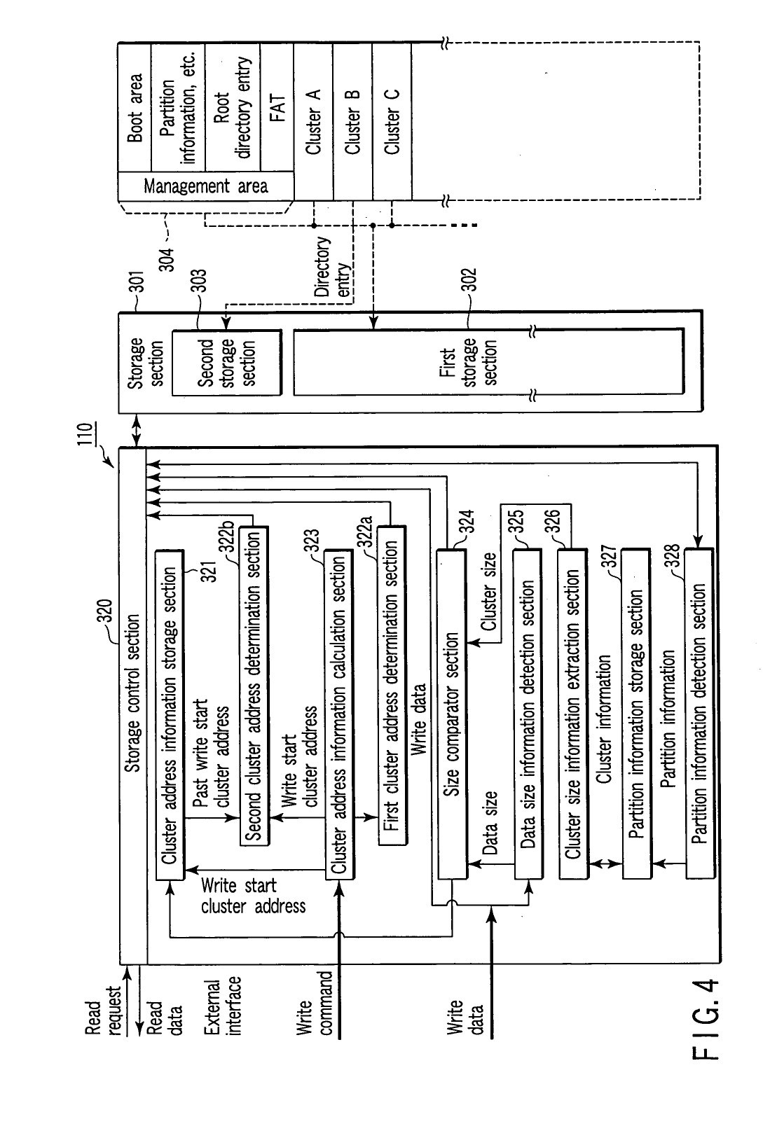

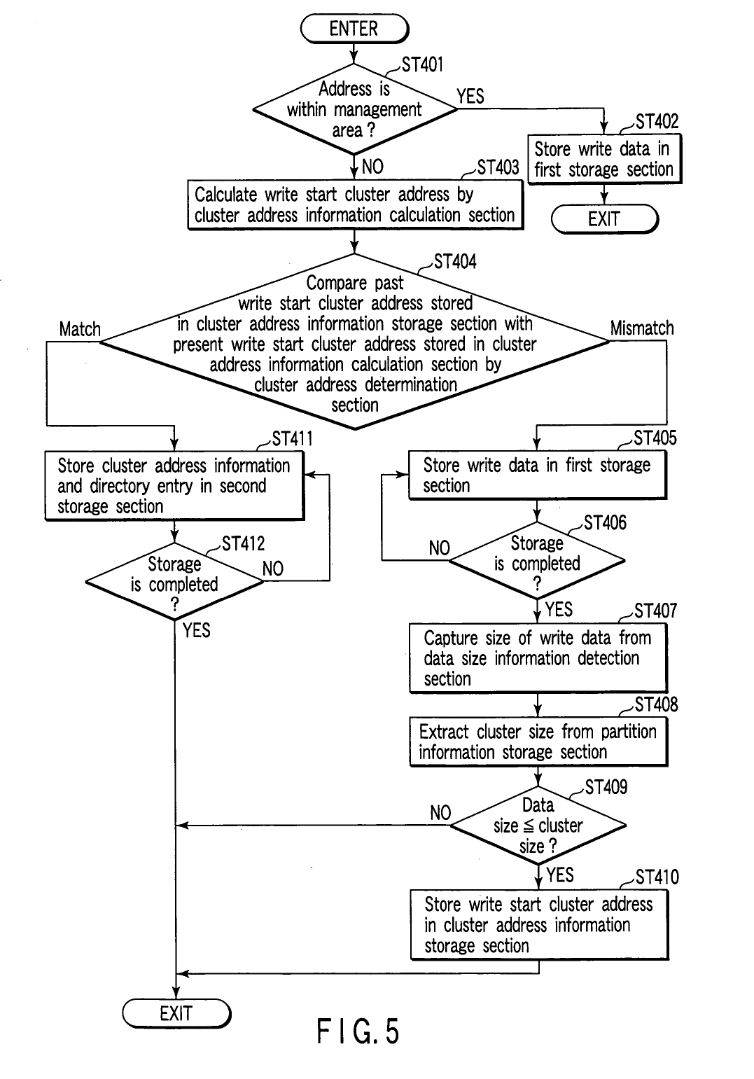

FIG. 4 and FIG. 5 show a second embodiment. Directory entry expresses one file or folder by 32 bytes. Thus, the number of directory entries storable in a 512-byte area is 16. For example, when continuously recording several files, the host device sequentially updates the directory entry for every file. This case, when 16 files are written, the write start address shifts by 512 bytes. In the first embodiment compares addresses. When 16 files are written, the write address needs to be changed into a different address. For this reason, data movement occurs when every 16 files are written; as a result, write performance is reduced. The second embodiment relates to the technique capable of solving the foregoing problem in the first embodiment.

In FIG. 4, a memory device is composed of storage section 301 and storage control section 320. The storage section 301 comprising a NAND type flash memory is composed of first and second storage sections 302 and 303. The first storage section 302 is stored with management area and several clusters A, B, C . . . n, like the first embodiment. The second storage section 303 corresponds to one cluster of the first storage section 302. A directory entry (sub-directory information) diverging from the management area of the system is written in the second storage section 303.

A control section 110 includes storage control section 320, cluster address information storage section 321, first and second cluster address determination section 322a and 322b and cluster address information calculation section 323. Further, the control section 110 includes size comparator section 324, data size information detection section 325, cluster size extraction section 326, partition information storage and detection sections 327 and 32.8.

The control section 110 is not limited to the configuration described above. For example, the control section 110 could comprise a microprocessor (not shown) and ROM or RAM storing programs necessary for the operation of the microprocessor, and may be controlled using software.

The foregoing storage control section 320, size comparator section 324, data size information detection section 325, cluster size extraction section 326, partition information storage and detection sections 327 and 328 are the same as those in the first embodiment.

The cluster address information calculation section 323 detects a write start address added to write command via external interfaces. The section 323 divides the write start address by cluster size, and calculates the integer part of the division result as a write start cluster address.

The cluster address information storage section 321 stores the write start cluster address calculated by the foregoing section 323 in accordance with the control of the size comparator section 324.

The first cluster address determination section 322a determines whether or not the write start cluster address calculated by the section 323 is an address within the management area of the file system.

The second cluster address determination section 322b compares the write start cluster address calculated by the section 323 with write start cluster address information stored in the section 321. The comparative result is supplied to the storage control section 320.

FIG. 5 shows the write operation according to the second embodiment.

The cluster address information calculation section 323 detects a write start address added to write command via external interfaces. The section 323 divides the detected write start address by a cluster size to calculate a write start cluster address to which the write start address belongs (ST 401). Thereafter, the first cluster address determination section 322a determines whether or not the write start cluster address detected by the section 323 is an address within the management area (ST 402). As a result, if the write start cluster address is within the management area, data is written in the first storage section 302 according to the normal write (ST 403). In other words, data with respect to FAT and root directory is written according to the normal write.

On the other hand, if the write start cluster address is outside of the management area, the second cluster address determination section 322b makes the following determination. More specifically, the section 322b determines whether or not the write start cluster address detected by the section 323 is the same as the write start cluster address information stored in the section 321. In other words, it is determined whether or not write is made with respect to the cluster address in the past (ST 404).

As a result, if the write start cluster address is an address having no write in the past, write data is stored in the first storage section (ST 405, ST 406). In this case, the data size information detection section 325 detects a size of the data written in the memory device via the external interface.

When data storage to the first storage section 302 is completed, the size comparator section 324 captures a size of the data written in the first storage section 302 from the data size information detection section 325 (ST 407). Further, the section 324 captures a cluster size extracted by the partition information storage section 327 from the cluster size extraction section 326 (ST 408). Then, the size comparator section 324 compares the size of the written data with the cluster size (ST 409).

As a result, if the data size is less than the cluster size, the write data is determined as write to directory. The write start cluster address detected by the cluster address information calculation section 323 is stored in the cluster address information section 321 (ST 410). If the data size is larger than the cluster size, the normal write operation is carried out.

In the comparison result in step ST 404, if the write cluster address matches with the cluster address stored in the address information storage section 321; in other words, if data write is made with respect to the cluster address in the past, the present write data is regarded as write to directory entry. Due to this, data is once written in the second storage section 303 provided for directory entry (ST 411, ST 412).

Further, the data stored in the second storage section 303 has the following cases. One is a case where only write data having a write request is stored. Another is a case where updated data in the cluster is updated as cluster data to store the cluster itself in the second storage section 303. In either case, in order to specify which write data belongs to which address of clusters, a redundancy storage area of the second storage section 303 stores a flag indicative of an address, like the first embodiment.

According to the second embodiment, the cluster address information calculation section 323 divides the write start address detected from write command by the cluster size to calculate write start cluster address to which the write start address belongs. The cluster address determination section 322 determines the write data as write to directory entry, and once writes data in the second storage section 303 in the following case. This is the case where the cluster address information stored in the section 321 matches with the cluster address information detected by the cluster address information calculation section 323. Therefore, even if a sub-directory is set in the hierarchy lower than the root directory, it is possible to prevent the reduction of write speed.

Directory entry expresses one file or folder by 32 bytes. Thus, the number of directory entries storable in a 512-byte area is 16. For example, the host device has the directory entry size of 15 k-bytes, and the update size of 512 bytes. In the host device, if directory entry is sequentially updated every when the file is written; entries relevant to 16 files are storable in 512 k-bytes. In this case, the write start address shifts by 512 bytes when 16 files are written. The first embodiment compares addresses. When 16 files are written, the write address need to be changed into a different address. Thus, data is not written in the second storage section, which is in a write-once state. On the contrary, according to the second embodiment, even if the address shifts by 512 bytes, the address is regarded as the same cluster address in the same cluster range. Therefore, if the cluster size is 16 k-bytes, there is no occurrence of data movement performed for directory entry of 510 files (=512−2 (the leading two entries of the directory are parent directory, and information relevant to the self-directory)). As a result, a high-speed write operation can be achieved.

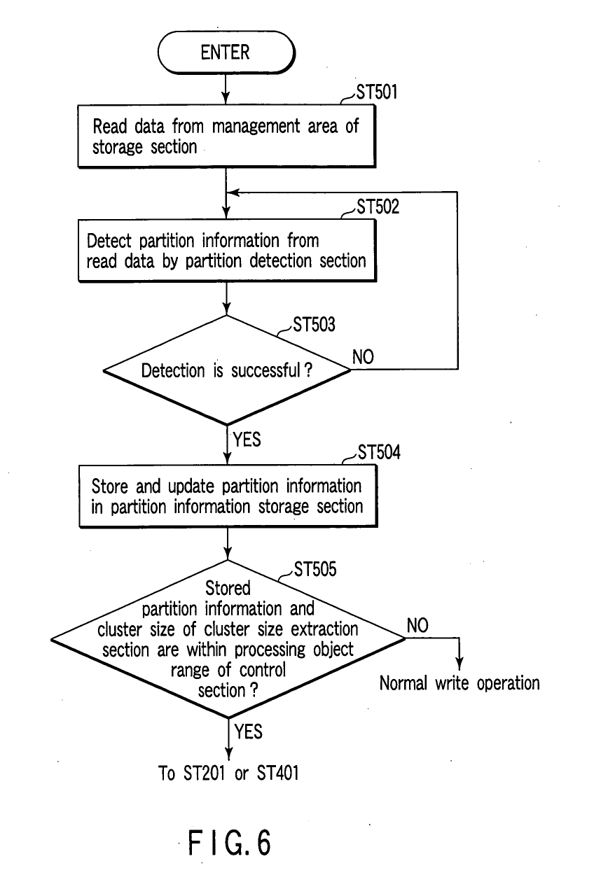

The operation up to the active state of the memory device described in the first and second embodiments will be explained below with reference to FIG. 6. The boot operation of the memory device is the same in the first and second embodiments; therefore, the boot operation of the first embodiment will be exemplified.

When the memory device powers on, a read request is supplied from the host device to the storage control section 120. The storage control section 120 reads data stored in the management area from the storage section 101 in accordance with the read request, and thereafter, transfers the data to the host device (ST 501). The partition information detection section 128 detects partition information from the read data (ST 502, ST 503). As a result, if the partition information is detected (ST 504), partition information stored in the partition information storage section (127, 327) is updated and stored (ST 504).

The host device determines whether or not the kind of file system and cluster size are processing objects based on partition information included in the read data supplied from the storage control section 120 via the external interface (not shown)(ST 505). As a result, if the kind of file system and the cluster size are processing objects, the control proceeds to ST 201 shown in FIG. 2 or ST 401 shown in FIG. 5. If the kind of file system and the cluster size are not determined to be processing objects, the normal write operation using no second storage section is carried out.

As described above, when the memory device activates, it is determined where or not the kind of file system and the cluster size are processing objects. By doing so, it is possible to prevent malfunction, and to achieve high-speed processing.

In the first and second embodiments, the size comparator section 124, 324 compares the cluster size with the data size. However, the present invention is not limited to the foregoing embodiment. For example, the size comparator section 124, 324 could compare a predetermined value smaller than the cluster size with the data size. If the data size is less than the predetermined value, the write data address may be stored in address information storage section 121 or cluster address information storage section 321. More specifically, if the cluster size is 16 k-bytes, the predetermined value is set as 4 k-bytes. If the write data size is less than 4 k-bytes, the write data address may be stored in address information storage section or cluster address information storage section.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory device comprising:
a control section; and
a storage section,
the control section including:
an address information detection section detecting address information from a write command including the address information;
an address information storage section storing address information; and
a first address determination section determining whether or not the address information detected by the address information detection section matches with the address information stored in the address information storage section,
wherein the storage section includes first and second storage section, and
the control section stores directory entry information corresponding to the address information in the second storage section when receiving matching information from the first address determination section.

2. The device according to claim 1, wherein the storage section has a management area storing information for managing the first and second storage sections.

3. The device according to claim 2, further comprising:
a second address determination section determining whether or not the address information detected by the address information detection section matches with the address information within the management area,
wherein the control section stores directory entry information corresponding to the address information in the management area when receiving matching information from the second address determination section.

4. The device according to claim 1, wherein the control section further includes:
a data size information detection section detecting data size information of write data added to the write command; and
a size comparator section comparing the data size information detected by the data size information detection section with size information preset in the storage section,
wherein the control section stores the address information detected by the address information detection section in the address information storage section when the data size information is less than the size information.

5. The device according to claim 1, wherein the control section further includes:
a partition information detection section detecting partition information and cluster information of the storage section,
wherein when the partition information or the cluster information detected by the partition information detection section is not within an object range of the control section, write is carried out with respect to the storage section without using the second storage section.

6. The device according to claim 3, wherein the management area stores a root directory entry, and the second storage section stores a directory entry of sub-directory.

7. The device according to claim 2, wherein the storage section comprises a NAND type flash memory.

8. A memory device comprising:
a control section;
a storage section;
an address information detection section detecting address information from a write command including the address information;
a cluster address information calculation section calculating cluster address information from address information detected by the address information detection section and cluster size information preset in the storage section;
a cluster address information storage section storing the cluster address information supplied from the cluster address information calculation section; and
a cluster address determination section determining whether or not the cluster address information calculated by the cluster address information calculation section matches with the cluster address information stored in the cluster address information storage section,
wherein the storage section includes first and second storage section, and
the control section stores directory entry information corresponding to the cluster address information in the second storage section when receiving matching information from the cluster address determination section.

9. The device according to claim 8, wherein the storage section has a management area storing information for managing the first and second storage sections.

10. The device according to claim 9, further comprising:
an address determination section determining whether or not the address information detected by the address information detection section matches with the address information within the management area,
wherein the control section stores directory entry information corresponding to the address information in the management area when receiving matching information from the address determination section.

11. The device according to claim 8, wherein the control section further includes:
a data size information detection section detecting data size information of write data added to the write command; and
a size comparator section comparing the data size information detected by the data size information detection section with size information preset in the storage section,
wherein the control section stores the cluster address information detected by the cluster address information detection section in the cluster address information storage section when the data size information is the same as the size information or smaller than that.

12. The device according to claim 8, wherein the control section further includes:
a partition information detection section detecting partition information and cluster information of the storage section,
wherein when the partition information or the cluster information detected by the partition information detection section is not within an object range of the control section, write is carried out with respect to the storage section without using the second storage section.

13. The device according to claim 10, wherein the management area stores a root directory entry, and the second storage section stores a directory entry of sub-directory.

14. The device according to claim 13, wherein the directory entry is once written in the second storage section.

15. The device according to claim 12, wherein the storage section comprises a NAND type flash memory.

16. A storage method of a memory device comprising:
detecting an address information from a write command including the address information;
determining whether or not the detected address information matches with an address information stored in an address information storage section, and storing write data in a first storage section of a storage section when the detected address information does not match with the address information stored in an address information storage section;
storing the detected address information in the address information storage section when the data size of the write data is smaller than size information preset in the storage section; and
storing directory entry information corresponding to the cluster address information in the second storage section when the detected address information matches with the address information stored in an address information storage section.

17. The device according to claim 16, wherein the storage section comprises a NAND type flash memory.

18. A storage method of a memory device comprising:
detecting address information from a write command including the address information;
calculating a cluster address information from address information detected by the address information detection section and cluster size information preset in the storage section;
determining whether or not the calculated cluster address information matches with the cluster address information stored in the cluster address information storage section, and storing write data in a first storage section of a storage section when the calculated cluster address information does not match with the cluster address information stored in the cluster address information storage section;
storing the calculated cluster address information in the address information storage section when the data size of the write data is smaller than size information preset in the storage section; and
storing directory entry information corresponding to the cluster address information in the second storage section when the calculated cluster address information matches with the cluster address information stored in the cluster address information storage section.

19. The method according to claim 18, wherein the storage section comprises a NAND type flash memory.
